(19) United States
(12) Patent Application Publication
(10) Pub. No.: US 2015/0081648 A1
(43) Pub. Date: Mar. 19, 2015

(54) Method of Composing an Integrated Ontology

(71) Applicants: Sonja Zillner, Munchen (DE); Heiner Oberkampf, Munchen (DE); Peter Rosina, Augsburg (DE); Melanie Langermeier, Munchen (DE); Thomas Driessen, Augsburg (DE)

(72) Inventors: Sonja Zillner, Munchen (DE); Heiner Oberkampf, Munchen (DE); Peter Rosina, Augsburg (DE); Melanie Langermeier, Munchen (DE); Thomas Driessen, Augsburg (DE)

(21) Appl. No.: 14/029,270

(22) Filed: Sep. 17, 2013

(51) Int. Cl. G06F 17/30

(52) U.S. Cl. CPC G06F 17/30371
USPC 707/690

(57) ABSTRACT

A method of composing an integrated ontology is provided. The method makes use of feature models for the process of modular development of ontologies. The feature models are adapted to assist the user in the process of selection of appropriate and combinable ontologies from an ontology repository for a given use case scenario. The usage of a feature model provides a view of all possible combinations, i.e. all combinations that do not result in an inconsistent ontology. The feature model is specifying dependencies between different ontologies thereby expediting the selection of appropriate ontologies. The usage of reasoning techniques provides for an in-situ consideration of restrictions for the selection of ontologies.

### TECHNICAL FIELD

The present embodiments relate to a method of composing an integrated ontology from a set of ontologies.

### BACKGROUND

An ontology is understood as a formal specification of terminology and concepts, as well as the relationships among those concepts, relevant to a particular domain or area of interest. Ontologies provide insight into the nature of information particular to a given field and are essential to any attempts to arrive at a shared understanding of the relevant concepts. They may be specified at various levels of complexity and formality depending on the domain and information needs of the participants in a given conversation. Ontologies are used for various applications such as data standardization, integration and many knowledge based systems.

Currently known approaches in the field of ontology development are confronted with a growing size and complexity of applied ontologies. Particularly domain ontologies in the field of biomedicine exhibit a vast quantity of entities and relations between these entities, respectively. In addition, these entities are growingly interlinked and so raising the complexity of an ontology. An extensive use of logical definitions makes ontological inference impractical in large scale applications. Moreover, large ontologies are difficult to maintain as amendments of an existing large ontology potentially influence the whole structure. Finally it is difficult to reuse existing ontologies of even parts thereof.

These problems are currently addressed by a modular ontology development aiming to provide consistent ontology modules of low size and complexity in order to compose an integrated ontology from a set of ontologies, thereby designing the integrated ontology in dependence of a specified use-case.

### SUMMARY AND DESCRIPTION

Currently known procedures in selecting and integrating ontologies have two major drawbacks. First, in order to prevent the integrated ontology of an inflated size, a selection of ontologies is suitable only for entities and relations with relevance for the specified use-case. Second, since ontologies are generally logical models, some combinations leading to inconsistent models are excluded.

Currently known procedures, however, cannot aid a selection of appropriate ontologies for a given use case. Still ontology developers need to manually inspect existing ontology repositories in order to select suitable and compatible ontologies for a given use-case.

Accordingly there is a need in the art for a method for composing an integrated ontology aiding a selection of ontologies suitable for a given use-case, while at the same time verifying a consistency of the integrated ontology during the process of composition.

Systems and methods in accordance with various embodiments provide for a composition of an integrated ontology from a set of ontologies.

In one embodiment, a method of composing an integrated ontology from a set of ontologies is disclosed, including the steps of:
a) providing at least one feature model, said feature model specifying possible and consistent alignments between ontologies of said set of ontologies;
b) presenting a node view of said set of ontologies by instantiating said feature model, at least one node representing one of said ontologies of said set of ontologies;
c) registering a selection of at least one first node, computing a restriction for at least one second node of said nodes considering said feature model and excluding a restricted second node from selection;
d) integrating ontologies represented by selected nodes into a preliminary integrated ontology;
e) checking a consistency of said preliminary integrated ontology; and;
f) building said integrated ontology from said preliminary integrated ontology for the case that said consistency is verified against said feature model.

According to an embodiment, a system for an ontology-based data access using a query is disclosed, the system comprising:
a) an interface to a repository including at least one feature model, the feature model specifying possible and consistent alignments between ontologies of said set of ontologies;
b) a user interface for presenting a node view of said set of ontologies by instantiating said feature model, at least one node representing one of said ontologies of said set of ontologies, the user interface adapted to register a selection of at least one first node;
c) a building component for integrating ontologies represented by selected nodes into a preliminary integrated ontology and for building said integrated ontology from said preliminary integrated ontology; and;
d) a reasoning component for computing a restriction for at least one second node of said nodes on selection of a first node of said nodes considering said feature model and excluding a restricted second node from selection, the reasoning component further checking a consistency of said preliminary integrated ontology and for verifying said consistency against said feature model.

According to an embodiment, a computer program product is disclosed.

### BRIEF DESCRIPTION OF THE DRAWING

These and other objects and advantages of the present invention will become more apparent and readily appreciated from the following description of the embodiments, taken in conjunction with the accompanying drawing of which:

FIG. 1 shows an exemplary embodiment of components; and

FIG. 2 shows an exemplary structure of a feature model.

### DETAILED DESCRIPTION

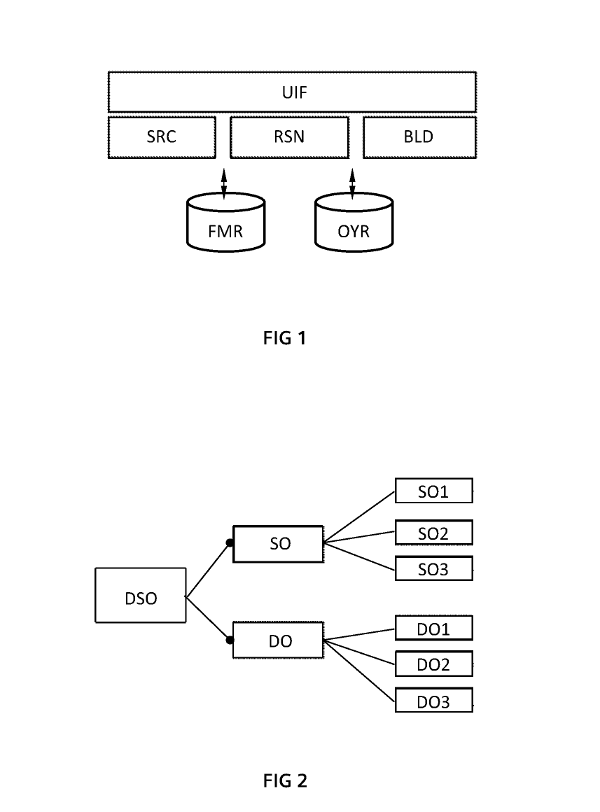

In FIG. 1 a block diagram of a system for composing an integrated ontology is depicted.

An ontology repository OYR contains a number of—not shown—ontologies for different domains. The ontology repository OYR optionally includes ontology mappings. The ontology repository OYR may further include information about the relation between ontologies included therein, such as import statements or information about compatibility of ontologies and between concepts from different ontologies. The ontology repository OYR may further include meta information about the contained ontologies, which is used by search mechanism described below.

A feature model repository FMR preferably includes different—not shown—feature models for domains such as biomedicine, healthcare or industry. At least one feature model specifies possible and consistent combinations and/or alignments of ontologies of the respective domain. Information about possible and consistent combinations might be obtained from the ontology repository OYR.

Information included in a feature model is preferably organized in a node structure. The nodes in the feature model represent or refer to ontologies included in the ontology repository OYR. Standard syntax of feature models is used in order to express possible combinations. The feature model repository FMR may further include feature diagrams for each feature model.

A search component SRC allows for a navigation through the feature model repository FMR in order to select a feature model appropriate for an intended use case. During a process of selection and restriction, the search component SRC provides information about ontologies included in the ontology repository OYR.

In an iterative process of selecting nodes of a feature model, an algorithm of a reasoning component RSN is executed. This algorithm computes restrictions for other nodes of the feature model according to the logic of the feature model. Additionally, while ontologies selected by their representing nodes are integrated into a preliminary integrated ontology, a consistency check of the preliminary integrated ontology is performed periodically. The consistency check is preferably performed upon integration of a selected ontology into the preliminary integrated ontology. Eventually, the consistency of a finalized preliminary integrated ontology is verified against said feature model leading to an integrated ontology composed for a specified use case.

A building component BLD is directing the aforementioned task of integrating selected ontologies into a preliminary integrated ontology. Dependent on the selected ontologies and the logic of the feature model, the building component BLD delivers a preliminary integrated ontology after each iteration step and, eventually, the final integrated ontology. The final integrated ontology for the use case is automatically created using the selection of ontologies derived by the feature model.

The building component BLD optionally checks the ontology repository OYR for available mapping ontologies.

A user interface UIF provides access to the search component SRC in order to select an appropriate feature model.

Subsequently, the user interface UIF is presenting the node view of ontologies by instantiating a selected feature model. Said instantiation creates an executable instance of the feature model allowing for an editable presentation of the node allowing for a selection of particular nodes and restricting other nodes from selection. The user interface UIF is either interfacing with a human operator or, additionally or alternatively, with other—not shown—machine-driven processes. The user interface UIF further supports navigating through the nodes of the feature model and selecting respective ontologies from the ontology repository.

Hereinafter, a process for composing an integrated ontology according to an embodiment is described. Composing an integrated ontology encompasses methods of alignment and integration of modular components of ontologies by automatically instantiation and processing of a related feature model from a feature model repository FMR.

In a first step, a feature model is selected from the feature model repository FMR using an intelligent ranking algorithm executed by the search component SRC. The feature model specifies possible and consistent alignments between ontologies administered by the ontology repository OYR. The algorithm of the search component SRC proposes appropriate feature models via the user interface UIF. A user selects an appropriate feature model, which is instantiated upon selection.

According to a subsequent step, a selection of ontologies is made. This step is iteratively repeated in accordance with an embodiment. The user navigates through nodes in a representation of a node view of the instantiated feature model and selecting respective ontologies from the ontology repository OYR be selecting a node assigned to the respective ontology. For each selection of a node, the search component SRC provides information about available ontologies.

According to a subsequent step, the reasoning component RSN ensures that each selection is performed according to the specification of the feature model. Additionally, the reasoning component RSN computes restrictions for other nodes of the feature model according to the logic of the feature model after the selection of a node and its respective ontology. On registering a selection of at least one first node, the reasoning component RSN is computing a restriction for at least one second node of said nodes considering said feature model and excluding a restricted second node from selection.

The ontologies selected by respective nodes are integrated into a preliminary integrated ontology and the reasoning component performs consistency checks.

On the event that the reasoning component RSN is detecting that the number of selected ontologies meets the requirements of the feature model in terms of completeness or consistency, the user has the choice to finalize the selection process or, alternatively, add further optional ontologies. If the user chooses to finalize the selection process, the method continues by a building step in which the preliminary integrated ontology is verified against said feature model.

The building component BLD integrates all selected ontologies. The ontology repository OYR is optionally queried for available ontology mappings, which might be selected by the user and integrated into the integrated ontology by the building component BLD.

Prior or previous to said building of the final integrated ontology, a reasoning component performs a consistency check on the preliminary integrated ontology or final integrated ontology, respectively.

The proposed method advantageously makes use of feature models for the process of modular development of ontologies.

The feature models are adapted to assist the user in the process of selection of appropriate and combinable ontologies from an ontology repository for a given use case scenario. The usage of a feature model advantageously provides a view of all possible combinations, i.e. all combinations which do not result in an inconsistent ontology. The feature model is advantageously specifying dependencies between different ontologies thereby expediting the selection of appropriate ontologies.

The advantageous usage of reasoning techniques provide for an in-situ consideration of restrictions for the selection of ontologies.

Turning now to FIG. 2 which illustrates a structure feature model according to an embodiment.

In an exemplary case in a medical domain, a developer of an ontology-based clinical application has to make a decision of which ontologies to use in which scenario. In the exemplary clinical application a relationship between information on diseases and information on symptoms has to be implemented.

The user has already selected an appropriate feature model for this task, which presentation by the user interface is exemplarily shown in FIG. 2.

The feature model specifies a disease-symptom-ontology, which is the use case integrated ontology to be developed, to include at least one symptom ontology SO and at least one disease ontology DO.

Further on, the symptom ontology SO has to contain at least one of the three symptom ontologies SO1,SO2,SO3 and the disease ontology DO has to contain at least one of the three disease ontologies DO1,DO2,DO3.

The user selects SO2. As SO2 turns out to be compatible with any other ontology, i.e. no restrictions are imposed by the reasoning component RSN, the user can either select another symptom ontology or one of the disease ontologies. The user selects the disease ontology DO2.

The reasoning component RSN checks whether both selected ontologies are indeed consistent if integrated. If this consistency of such a preliminary ontology is given, the selection process proceeds. DO2 is incompatible with SO1, SO3 and DO3, so the only possible ontology to select is DO1. The user can additionally select DO1 or not.

After choosing DO1 the building component BLD integrates all selected ontologies into one final disease symptom ontology DSO whereby existing mappings from the ontology OYR repository are added.

Drawing upon experiences with medical ontologies, the inventors have identified some of the common characteristics of medical ontologies that are relevant for the composition process. Medical ontologies can be summarized as being extremely large and having hierarchies up to ten thousands of classes with complex relationships. Furthermore, medical ontologies are typically rich in linguistic information.

Due to the outstanding complex nature of medical ontologies, the concepts according to the embodiments are seamlessly applicable for any kind of ontologies. The exemplary use of ontologies in the medical domain according to the described embodiment is, therefore, not restricting the proposed methods and embodiments to specific kinds of ontologies in any way.

Embodiments may be implemented in computing hardware (computing apparatus) and/or software, including but not limited to any computer that can store, retrieve, process and/or output data and/or communicate with other computers. The processes can also be distributed via, for example, downloading over a network such as the Internet. The results produced can be output to a display device, printer, readily accessible memory or another computer on a network. A program/software implementing the embodiments may be recorded on computer-readable media comprising computer-readable recording media.

The program/software implementing the embodiments may also be transmitted over a transmission communication media such as a carrier wave.

Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT).

Examples of the optical disk include a DVD (Digital Versatile Disc), a DVD-RAM, a CD-ROM (Compact Disc-Read Only Memory), and a CD-R (Recordable)/RW.

The invention has been described in detail with particular reference to preferred embodiments thereof and examples, but it will be understood that variations and modifications can be effected within the spirit and scope of the invention covered by the claims.

What is claimed is:

1. A method for composing an integrated ontology from a set of ontologies, including the steps of:
a) providing at least one feature model, said feature model specifying possible and consistent alignments between ontologies of said set of ontologies;
b) presenting a node view of said set of ontologies by instantiating said feature model, at least one node representing one of said ontologies of said set of ontologies;
c) registering a selection of at least one first node, computing a restriction for at least one second node of said nodes considering said feature model and excluding a restricted second node from selection;
d) integrating ontologies represented by selected nodes into a preliminary integrated ontology;
e) checking a consistency of said preliminary integrated ontology; and;
f) building said integrated ontology from said preliminary integrated ontology for the case that said consistency is verified against said feature model.

2. The method according to claim 1, repeating at least one of steps a), b), c), d) and e) until said consistency of said preliminary integrated ontology is verified against said feature model.

3. The method according to claim 1, including the step of adapting said feature model for the case that said consistency is lacking in step e).

4. A system for composing an integrated ontology from a set of ontologies, the arrangement comprising:
a) an interface to a repository including at least one feature model, the feature model specifying possible and consistent alignments between ontologies of said set of ontologies;
b) a user interface for presenting a node view of said set of ontologies by instantiating said feature model, at least one node representing one of said ontologies of said set of ontologies, the user interface adapted to register a selection of at least one first node;
c) a building component for integrating ontologies represented by selected nodes into a preliminary integrated ontology and for building said integrated ontology from said preliminary integrated ontology; and;
d) a reasoning component for computing a restriction for at least one second node of said nodes on selection of a first node of said nodes considering said feature model and excluding a restricted second node from selection, the reasoning component further checking a consistency of said preliminary integrated ontology and for verifying said consistency against said feature model.

5. A computer program product comprising program code stored on a non-transitory computer-readable medium and which, when executed on a computer, is configured to:
a) provide at least one feature model, said feature model specifying possible and consistent alignments between ontologies of said set of ontologies;
b) present a node view of said set of ontologies by instantiating said feature model, each node representing one of said ontologies of said set of ontologies;
c) register a selection of at least one first node, computing a restriction for at least one second node of said nodes and excluding a restricted node from selection;
d) integrate ontologies represented by selected nodes into a preliminary integrated ontology;
e) check a consistency of said preliminary integrated ontology; and;
f) build said integrated ontology from said preliminary integrated ontology for the case that said consistency is verified against said feature model.
